(19) United States
(12) Patent Application Publication
(10) Pub. No.: US 2003/0152672 A1
(43) Pub. Date: Aug. 14, 2003

(54) Candy sucker

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US); Walter F. Klima JR., Travelers Rest, SC (US); William L. Klima, Fredericksburg, VA (US)

Correspondence Address: WILLIAM L. KLIMA, A PROFESSIONAL CORPORATION, 2046-C JEFFERSON DAVIS HIGHWAY, STAFFORD, VA, 22554, US

(21) Appl. No.: 10/071,225

(22) Filed: Feb. 11, 2002

(51) Int. Cl. A23B 4/00

(52) U.S. Cl. 426/115

(57) ABSTRACT

The present invention is directed to a candy sucker article. Specifically, the candy sucker article includes a candy sucker in combination with a container having multiple compartments and/or multiple suckers.

### FIELD OF THE INVENTION

The present invention is directed to a candy sucker, in particular to a candy sucker article.

### BACKGROUND OF THE INVENTION

The concept of combining a candy sucker with a container storing an edible powder is disclosed in U.S. Pat. No. 5,370,884 to Thomas J. Coleman, which U.S. patent is incorporated herein by reference.

### SUMMARY OF THE INVENTION

A first object of the present invention is to provide an improved candy sucker article.

A second object of the present invention is to provide an improved candy sucker article including a sucker in combination with a container provided with multiple compartments simultaneously accessible when the container is open.

A third object of the present invention is to provide a candy sucker article including a sucker in combination with a container with multiple compartments selectively accessible when the container is opened.

A fourth object of the present invention is to provide a candy sucker article, including a container containing an edible product in which the container includes multiple compartments simultaneously or selectively accessible when the container is open, at least one closure connected to the container and at least one candy sucker associated with the container.

A fifth object of the present invention is to provide a candy sucker article having multiple candy suckers in combination with a container having multiple compartments.

A sixth object of the present invention is to provide a candy sucker article including multiple candy suckers in combination with a container having multiple compartments configured so that the multiple suckers can be dipped within the multiple compartments substantially simultaneously.

The present invention is directed to an improved candy sucker article. Specifically, the candy sucker article according to the present invention includes multiple candy suckers and/or multiple compartments of a container configured for and/or containing an edible product.

The present invention is directed to the concept of a candy sucker in combination with a container having multiple compartments which are simultaneously accessible when the container is open. For example, a closure of the container covers multiple compartments of the container, and when the closure is removed all multiple compartments are then accessible to the candy sucker.

Another concept of the present invention is to provide a candy sucker in combination with a container having multiple compartments selectively accessible when the container is open. For example, the container can be provided with multiple closures configured to selectively open one or more compartments to be accessible with the candy sucker while having an additional closure which can be opened to open one or more additional compartments to allow access with the candy sucker.

The article according to the present invention can be filled with contents or unfilled. Preferably, the container is filled with one or more food substances to define the article being sold at a point of sale to a consumer.

The container can be filled with candy, candy powder, candy granules, candy particles, candy liquid, candy gel, candy slurry, cookie, cookie crumbs, cookie powder, cookie particles, food powder, flavored powder, flavored granules, chocolate powder, vanilla powder, strawberry powder and other food matter. In some embodiments, it is desirable that the candy sucker is a different flavor and/or consistency with respect to the food contained within the container to provide a variety of flavors when using.

The candy sucker used in the article according to the present invention can take on various forms. Specifically, the candy sucker, for example, can be a hard candy sucker like a lollipop, or can be candy that is suitable to be dipped into another food product and then be licked. Preferably, the candy sucker is formulated to be more slowly dissolving versus the food product into which it is being dipped so that the user can repeatedly use the candy sucker for dipping out the food product from the container.

The candy sucker can be connected to other components of the article such as the container and/or closure, or can be a separate item associated with the article. Specifically, the candy sucker can be packaged (e.g. in a container, shrink wrapped, wrapped) together with the container having a closure. The candy sucker can be packaged within the container and/or closure.

### BRIEF DESCRIPTION OF THE DRAWINGS

FIG. 1 is a front elevational view of an embodiment of the candy sucker according to the present invention.

FIG. 2 is a front elevational view of another embodiment of the candy sucker according to the present invention.

FIG. 3 is a front elevational view of a further embodiment of the candy sucker according to the present invention.

FIG. 4 is a front elevational view of an even further embodiment of the candy sucker according to the present invention.

FIG. 5 is a front elevational view showing two (2) separate lollipops defining the upper lid, as an alternative to the upper lid shown in FIG. 3.

FIG. 6 is a front elevational view showing two (2) separate lollipops defining the upper lid, as an alternative to the upper lid shown in FIG. 4.

FIG. 7 is a side elevational view of a hinged top version of a candy sucker according to the present invention with the lid in the closed position.

FIG. 8 is a side elevational view of a hinged top version of a candy sucker according to the present invention with the lid in the open position.

FIG. 9 is a side elevational view of a lollipop in combination with a candy sucker according to the present invention packaged together.

FIG. 10 is a side elevational view of another embodiment of the candy sucker according to the present invention.

FIG. 11 is a side elevational view of another embodiment of the candy sucker according to the present invention.

FIG. 12 is a front elevational view of another embodiment of the candy sucker according to the present invention.

FIG. 13 is a front elevational view of another embodiment of the candy sucker according to the present invention in the version of a shovel and pail.

FIG. 14 is a side elevational view of a candy sucker according to the present invention including a dinosaur head styled upper lid.

FIG. 15 is a side elevational view of another embodiment of the candy sucker according to the present invention including a partial soccer ball defining an upper lid.

FIG. 16 is a side elevational view of a candy sucker according to the present invention having an “alien” theme with the upper lid secured to the container.

FIG. 17 is a side elevational view of a candy sucker according to the present invention having an alien theme with the upper lid is separated from the container.

FIG. 18 is a front elevational view of a candy sucker according to the present invention including an insect object defining a portion of the upper lid.

FIG. 19 is a front elevational view of a candy sucker according to the present invention in the configuration of a rocket ship.

FIG. 20 is a side elevational view of a candy sucker according to the present invention wherein the sucker is thumb-shaped.

FIG. 21 is a side elevational view of the candy sucker shown in FIG. 20, however, with the thumb-shaped sucker disposed within the container.

FIG. 22 is a side elevational view of an alternative embodiment to the one shown in FIGS. 20 and 21, with a thumb-shaped lollipop.

FIG. 23 is a perspective view of a candy sucker having a “basketball” theme with the candy sucker to be connected to the outside of the container.

FIG. 24 is a perspective view of the embodiment of the candy sucker as shown in FIG. 23, with the lid portion open and the candy sucker about to be disposed therein.

FIG. 25 is a front elevational view of a candy sucker according to the present invention showing a “basketball” theme with a basket and backboard mounted on a base.

FIG. 26 is a side elevational view of the “basketball” theme shown in FIG. 25.

FIG. 27 is a front elevational view of a candy sucker according to the present invention imitating an oyster.

### DETAILED DESCRIPTION OF PREFERRED EMBODIMENTS

A preferred embodiment of a candy sucker 10 according to the present invention is shown in FIG. 1.

The candy sucker 10 includes a lower container 12, a removable upper lid 14, a removable cover 16 and a removable lollipop 18. The lower container 12 is split into two compartments 12a and 12b by a dividing wall 20. The upper lid 14 is removable from the lower container 12 by the threaded connection defined by the outer threaded flange 22 of the upper lid 14 cooperating with the inner threaded edge 24 of the lower container 12. A snap fit connection is provided between the removable cover 16 and upper lid 14. Specifically, the upper lid 14 is provided with a flange 26 cooperating with a inner sleeve 28 of the removable cover 16, with an interference type connection therebetween.

In this particular embodiment, the lollipop 18 is removable from the upper lid 14. Specifically, the lollipop 18 is defined by the hard candy portion 18a connected to the stick portion 18b, and the free end of the stick portion 18b is disposed within an aperture 30 on the upper surface of the upper lid 14. The free end of the stick portion 18b and the diameter and shape of the aperture 30 are selected so as to provide a slight interference fit therebetween so that the sucker is removable, however, remains connected during use.

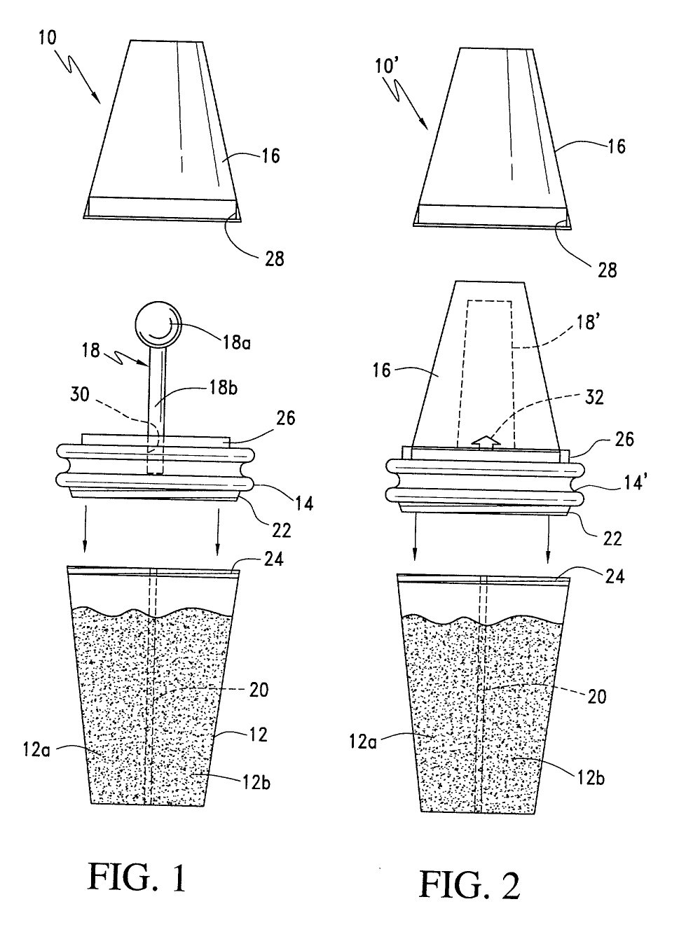

An alternative to the embodiment as shown in FIG. 1, is shown in FIG. 2.

The candy sucker 10′ utilizes the same lower container 12 and removable cover 16, however, the upper lid 14′ has been modified so that the lollipop 18′ is directly connected to the lid portion. Specifically, the upper lid 14′ is provided with a protrusion 32 extending upwardly to connect with a lower portion of the lollipop 18′. For example, the protrusion 32 can be injection molded with the upper lid 14 out of a plastic material, and then the lollipop 18 is molded around the protrusion 32.

In the embodiment shown in FIGS. 1 and 2, a single lollipop is utilized with a container having two separate compartments. The two separate compartments 12a and 12b can contain food, in particular powdered or granular candy. The two separate compartments can contain the same or different flavored powdered or granular candy to allow for different flavoring. The powder or granular candy can have different colors and the lower container 12 and removable cover 16 can be clear or translucent to allow a user to view the various colored candy products contained in this particular package. Alternatively, the two separate compartments can be replaced with three or more separate compartments to further add a variety of flavors and/or colors.

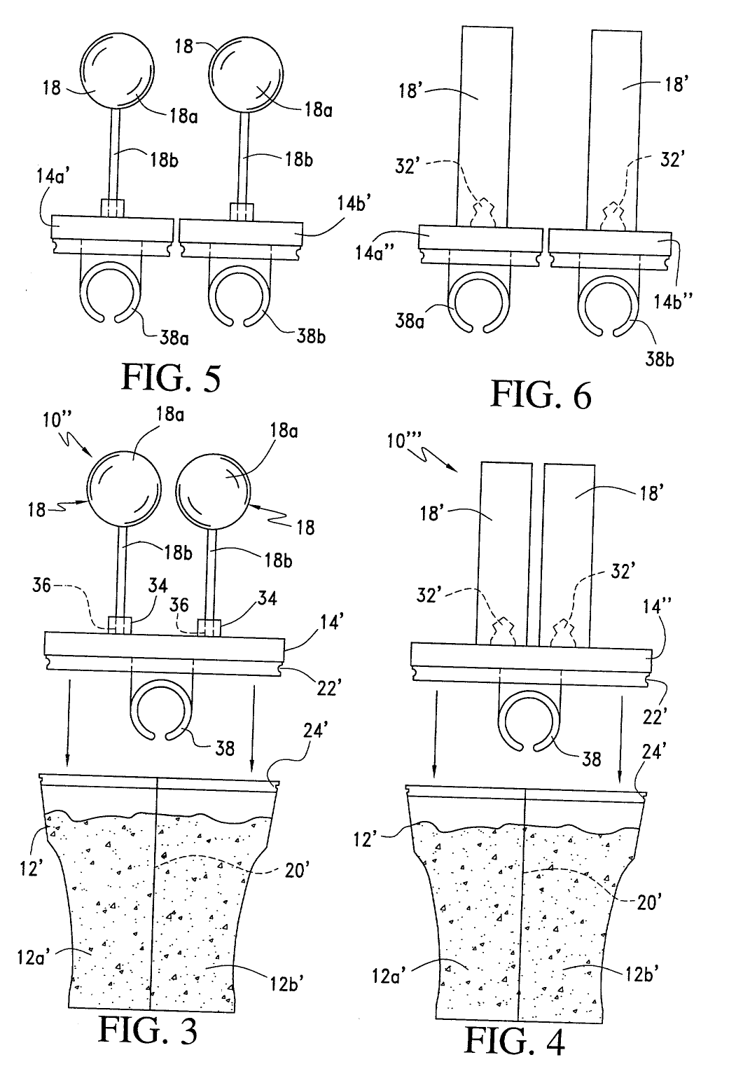

Further embodiments of the candy sucker according to the present invention are shown in FIGS. 3 and 4.

The embodiment shown in FIG. 3, a pair of spaced apart lollipops 18 are releasably connected to the upper lid 14′. The upper lid 14′ is provided with a pair of spaced apart protrusions 34 each having an aperture 36 for receiving the free end of the stick portion 18b of lollipops 18. A finger grip portion 38 extends downwardly from the upper lid 14′. In the embodiment shown in FIG. 4, the lollipops 18′ are directly connected to the upper lid 14′ by a pair of spaced apart protrusions 32′.

As shown in FIGS. 5 and 6, the upper lid shown in FIGS. 3 and 4 has been split into separate upper lid portions 14a′ and 14b′. In the embodiment shown in FIGS. 6, the upper lid 14″ shown in FIG. 4 has been split into two separate upper lid portions 14a″ and 14b″. In the embodiment shown in FIGS. 3 and 4, when the upper lid 14′ is removed, both compartments 12a′ and 12b′ are accessible to the lollipops 18. In the embodiments shown in FIGS. 5 and 6, the upper lid portions 14a′, 14b′, 14a″ and 14b″ can be selectively removed from the lower containers 12′ respectively, so that the compartments 12a′ and 12b′ can be selectively accessed by the lollipops 18.

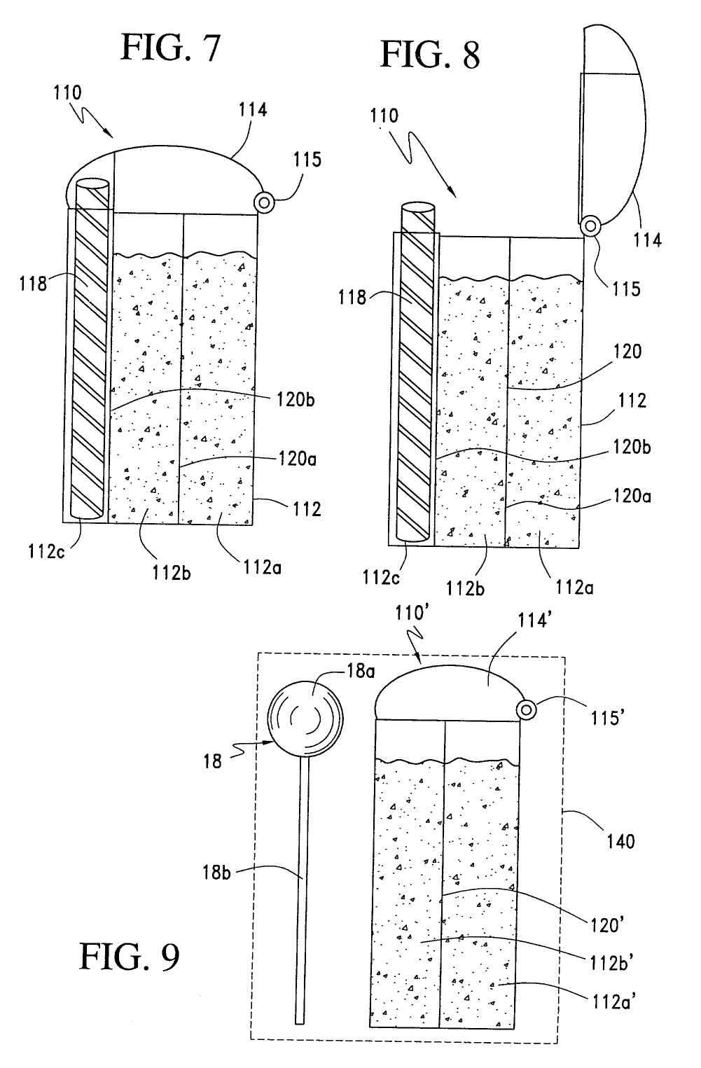

An even further embodiment of the present invention is shown in FIGS. 7, 8 and 9.

In the embodiment shown in FIGS. 7 and 8, a lower container 112 is connected to an upper lid 114 by a hinge 115 (e.g. live hinge or multi-component hinge). The lower container 112 is split into three (3) separate compartments 112a, 112b and 112c. For example, the compartments 112a and 112b can contain a powdered or granulated fruit product or candy. A separate hard candy 118 (e.g. candy cane) can be stored in the third separate compartment 12c. The upper lid 114 is opened to allow a user to remove the hard candy 118 and dip same in one or both separate compartments 12a and 12b. Alternatively, the lower container 112′ can be two (2) separate compartments, as shown in FIG. 9, and a lollipop 18 is shown packaged (indicated by dashed lines) with the assembled unit defined by the lower container 112′ and the upper lid 114′. The package 140 can be a wide variety of different packaging, including a paper box, a plastic see through container, shrink wrapping, blister packing or any other type of suitable packaging to associate the lollipop 18 with the assembled container. In the embodiment shown in FIGS. 7 and 8, the separate compartments are defined by dividing walls 120a and 120b. In the embodiment shown in FIG. 9, the compartments 112a′ and 112b′ are defined by dividing wall 120′.

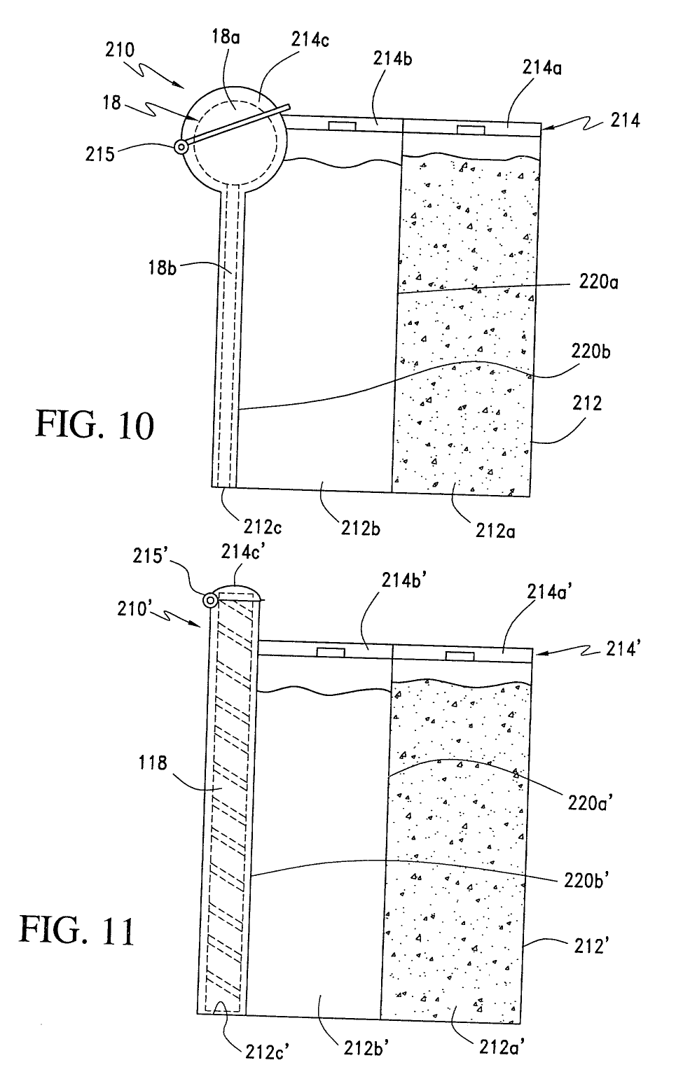

Additional embodiments similar to one shown in FIGS. 7-9 are shown in FIGS. 10 and 11. The embodiment shown in FIG. 10, the upper lid 214 is divided into three (3) separate upper lid portions 214a, 214b and 214c. The upper lid portions 214a and 214b can be hinged to the lower container 212, or fully removable. The upper lid portions 214c is connected to the lower container 212 by hinge 215. In the embodiment in FIG. 11, the upper lid 214′ is split into three (3) separate upper lid portions 214a′, 214b′ and 214c′. The lid portions 214a′ and 214b′ can be hinged to the lower housing 212′ or fully removable. The upper lid portion 214c′ is connected to the lower container 212′ by hinge 215′.

In the embodiment shown in FIGS. 7-9, the compartments containing the powdered or granulated food or candy become simultaneously accessible upon opening the lid 114 and 114′, respectively. In the embodiment shown in FIGS. 10 and 11, the upper lid portions 214a, 214b, 214c, 214a′, 214b′ and 214c′ can be selectively opened to provide selective access to the various compartments.

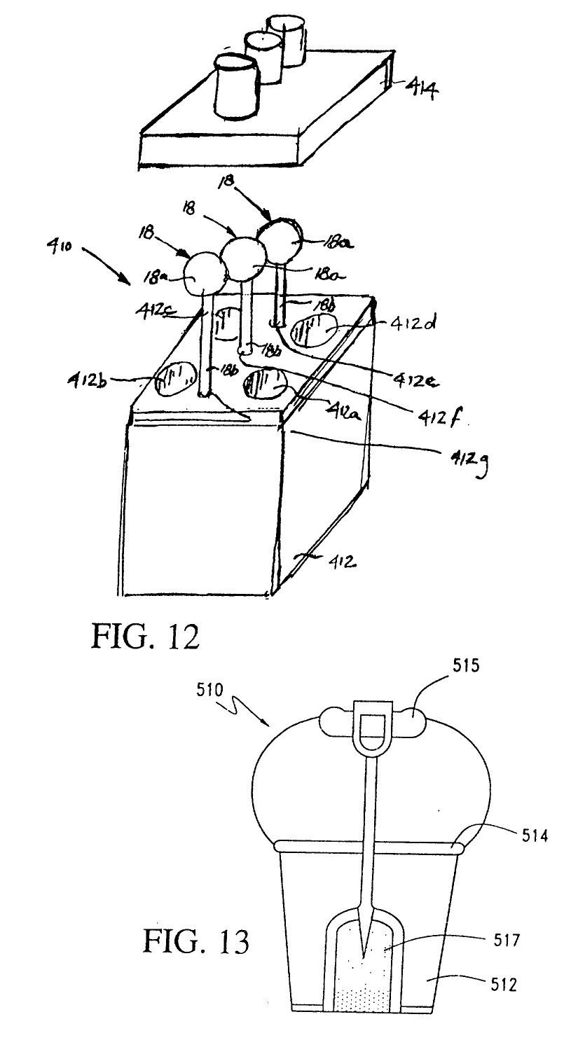

Another embodiment of the candy sucker 410 according to the present invention is shown in FIG. 12 similar in format to a “LEGO” block. In this particular embodiment, the container 412 is provided with four (4) compartments 412a, 412b, 412c and 412d and a removable lid 414. The container 412 is also provided with compartments 412e, 412f and 412g to provide holders for the three (3) suckers as shown. In this particular embodiment, the container 412 is a single piece with the compartments 412a, 412b, 412c and 412d provided therein. For example, the container 412 can be made of injection molded plastic.

The candy sucker according to the present invention can have various formats. For example, as shown in FIG. 13, the candy sucker 510 includes a lower container 512 and an upper lid 514. The container 512 is provided with a handle 515 to which a hard candy shovel 517 is releasably connected. A user grips the shovel 517 and removes it from the handle 515 and then removes the upper lid 514 to provide access.

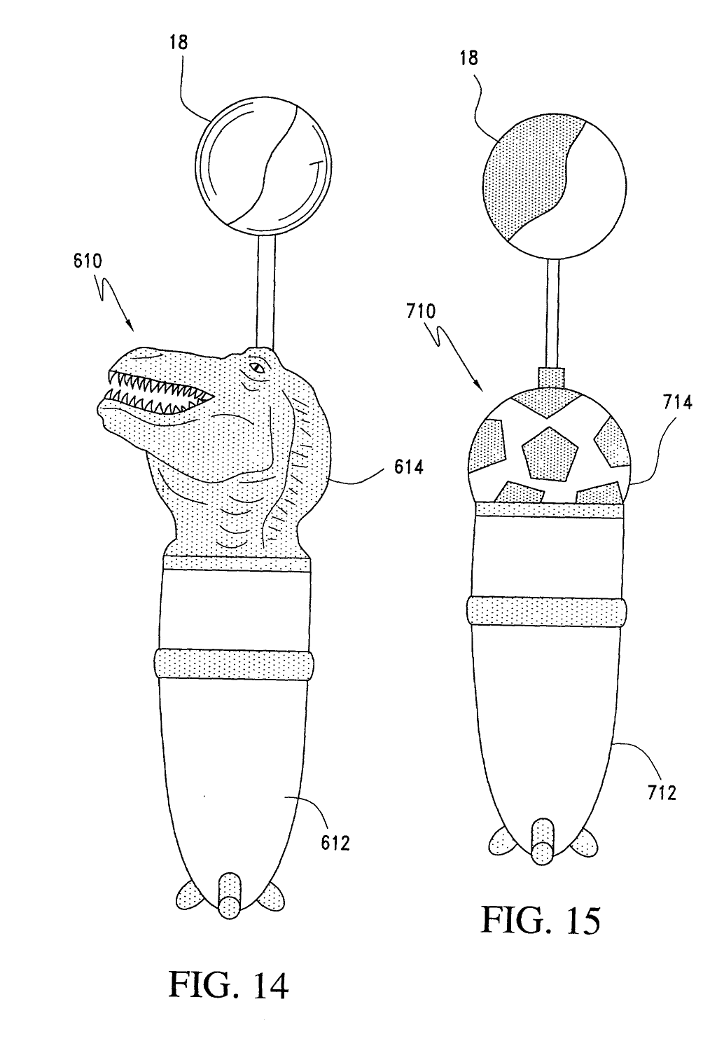

A “character” version of the candy sucker according to the present invention is shown in FIG. 14. In this embodiment, the candy sucker 610 includes a lower container 612 and an upper lid 614. The upper lid is configured to be the head of a dinosaur. In the embodiment shown in FIG. 15, the upper lid 714 is configured to exhibit a portion of a soccer ball.

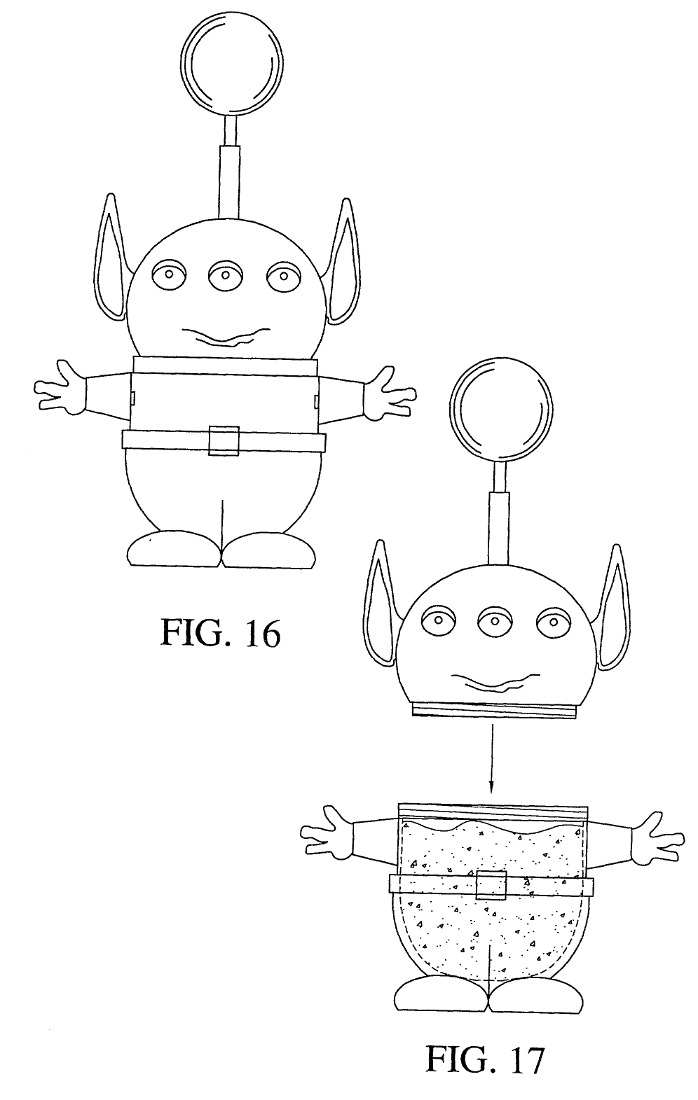

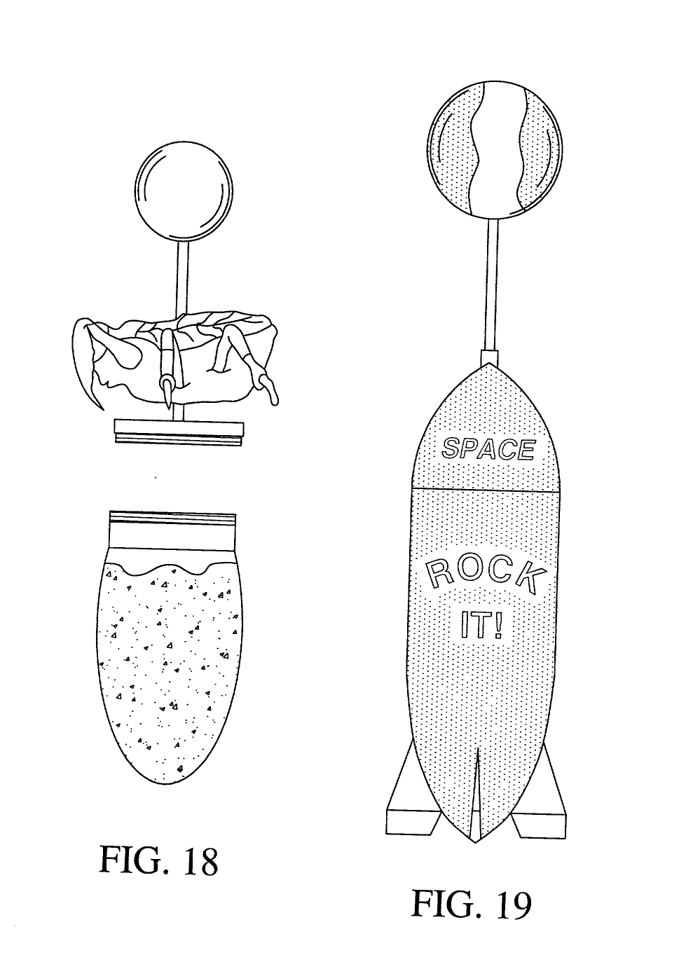

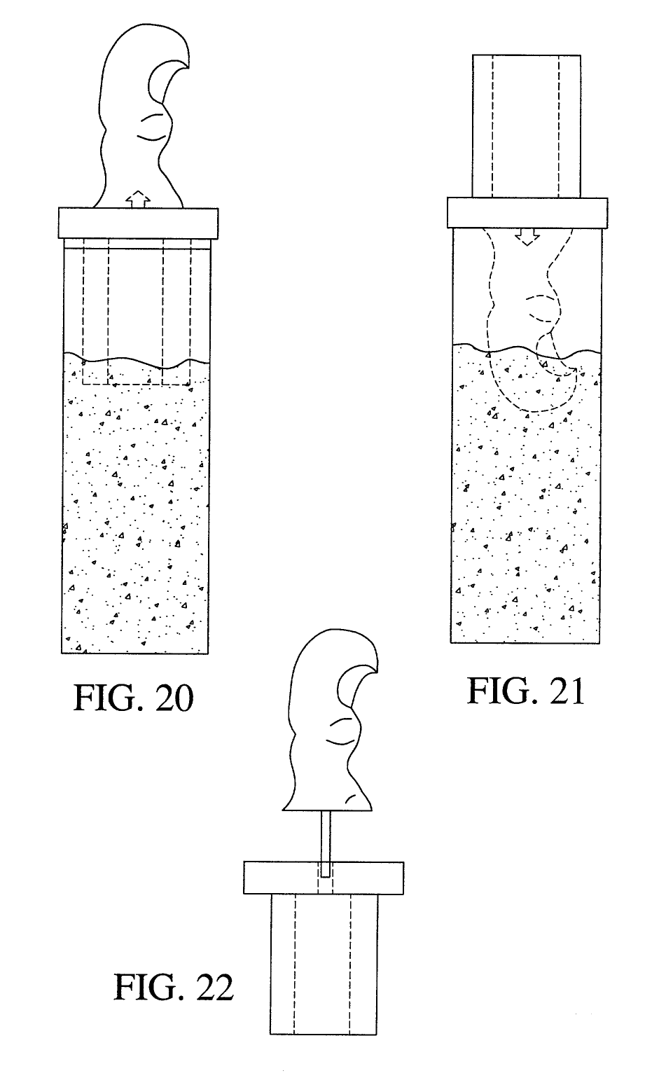

FIGS. 16 and 17 show an embodiment of the candy sucker according to the present invention using an “alien” figure. In the embodiment shown in FIG. 18, an insect figure is incorporated with the lid portion. In FIG. 19, the container is configured to be a rocket ship, and in FIGS. 20-22, the hard candy sucker is “thumb” shaped.

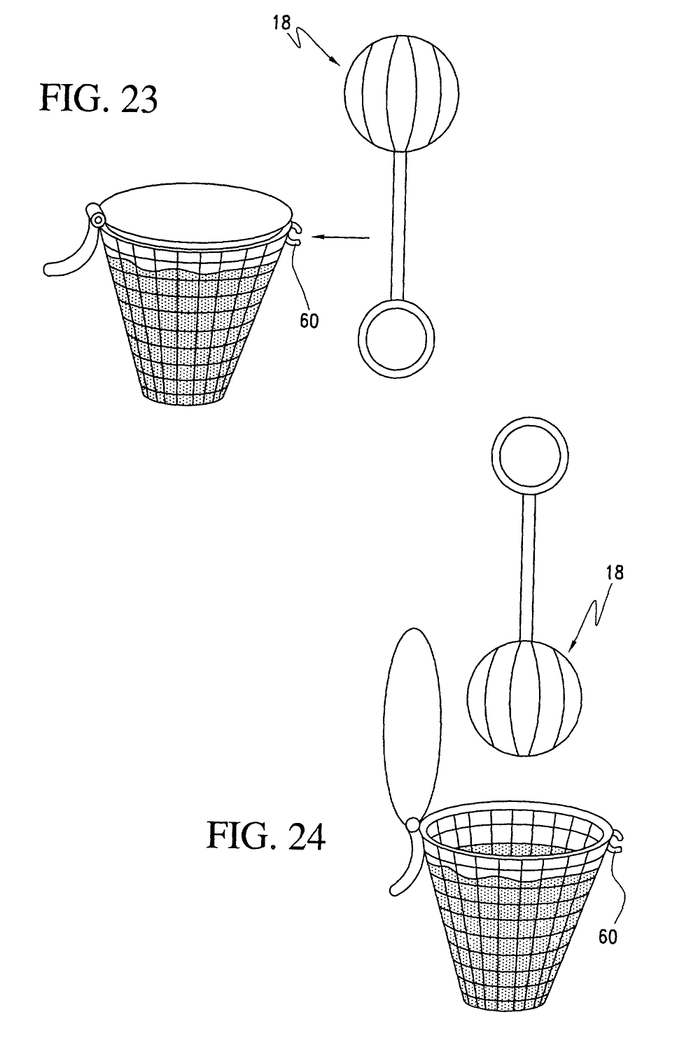

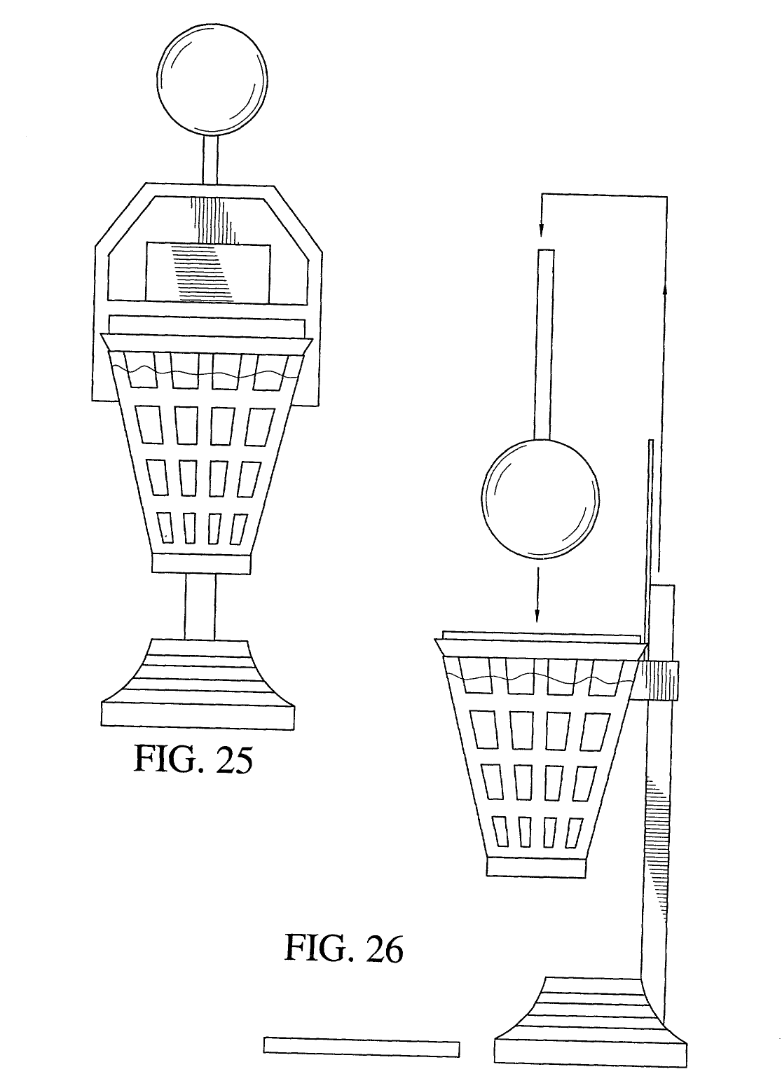

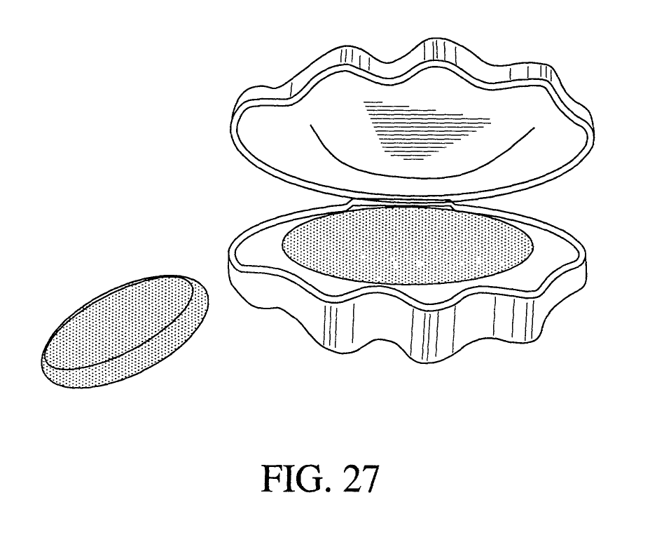

In FIGS. 23 and 24, a basketball-shaped sucker in combination with a basket styled container provide for a “basketball” theme. The sucker 18 can be clipped via the connector 60 to the container. In an alternative to the “basketball” theme shown in FIGS. 23 and 24, is the candy sucker shown in FIGS. 25 and 26. In this embodiment, the container is a basket and the sucker is attached to the backboard supported on a stand. Another embodiment is shown in FIG. 27 to look like an “oyster” with a circular-shaped candy used to dip within powder or granular candy contained within the shell portion.

What is claimed is:

1. A candy sucker article, comprising:
a container configured for containing an edible product, said container including multiple compartments simultaneously accessible when said container is opened;
a closure connected to said container; and
at least one candy sucker associated with said container.

2. An article according to claim 1, wherein said candy sucker is packaged with said container.

3. An article according to claim 1, wherein said closure is configured to be a replaceable closure.

4. An article according to claim 1, wherein said container includes a removable seal located between said closure and said container.

5. An article according to claim 3, wherein said container includes a removable seal located between said closure and said container.

6. An article according to claim 1, including multiple candy suckers associated with the candy sucker article.

7. An article according to claim 1, wherein said candy sucker is connected to said closure.

8. An article according to claim 6, wherein said candy suckers are connected to said closure.

9. An article according to claim 8, wherein said candy suckers are spaced apart, and said container and said closure are configured so that said candy suckers can be dip substantially simultaneously with multiple compartments of said container.

10. An article according to claim 1, wherein said candy sucker is directly connected to said closure.

11. An article according to claim 10, wherein said closure includes a protrusion, and said candy sucker is molded around said protrusion.

12. An article according to claim 1, wherein said candy sucker includes a candy portion mounted on a stick portion.

13. An article according to claim 12, wherein candy sucker is directly connected to the candy sucker article.

14. An article according to claim 13, wherein said closure includes an aperture configured to connected with a free end of said stick portion of said candy sucker.

15. An article according to claim 1, including at least one type of food stored within at least one compartment of said container.

16. An article according to claim 14, wherein said food is one selected from the group consisting of candy, candy powder, candy granules, candy particles, candy liquid, candy gel, candy slurry, cookie, cookie crumbs, cookie powder, food particles, food powder, flavored powder, flavored granules, chocolate powder, vanilla powder, strawberry powder and food matter.

17. An article according to claim 6, wherein said candy suckers are of different flavor.

18. An article according to claim 15, wherein said candy sucker is of a different flavor from said food stored within said container.

19. An article according to claim 1, wherein the candy sucker article displays a sports theme.

20. An article according to claim 19, wherein said sport theme includes one selected from the group consisting of golf, basketball, baseball, football, hockey, ice hockey, field hockey, soccer, lacrosse, swimming, racing, race car driving, NASCAR race car, water polo, tennis, and other sports.

21. An article according to claim 1, wherein said candy sucker article displays at least a portion of a character.

22. An article according to claim 21, wherein said character is one selected from the group consisting of an animal character, human character, cartoon character, story book character, novel character, children's book character, theme character, movie character, advertisement character, celebrity character and entertainment character.

23. An article according to claim 1, wherein said candy sucker displays a vehicle selected from the group consisting of motor vehicle, automobile, car, truck, pickup truck, sports utility vehicle (SUV), bus, van, boat, jet ski, personal water craft, ski mobile, rocket, airplane, glider, jet, bicycle, skate board, scooter, motorcycle and, mini bike.

24. A candy sucker article, comprising:
a container configured for containing an edible product, said container including multiple compartments selectively accessible when said container is opened;
at least one closure connected to said container; and
at least one candy sucker associated with said container.

25. An article according to claim 24, wherein said candy sucker is packaged with said container.

26. An article according to claim 24, wherein said closure is configured to be a replaceable closure.

27. An article according to claim 24, wherein said container includes a removable seal located between said closure and said container.

28. An article according to claim 26, wherein said container includes a removable seal located between said closure and said container.

29. An article according to claim 24, including multiple candy suckers associated with the candy sucker article.

30. An article according to claim 24, wherein the candy sucker article includes multiple closures configured to be selectively opened.

31. An article according to claim 24, including at least one type of food stored within at least one compartment of said container.

32. An article according to claim 31, wherein said food is one selected from the group consisting of candy, candy powder, candy granules, candy particles, candy liquid, candy gel, candy slurry, cookie, cookie crumbs, cookie powder, food particles, food powder, flavored powder, flavored granules, chocolate powder, vanilla powder, strawberry powder and food matter.
